(19) United States
(12) Patent Application Publication
(10) Pub. No.: US 2007/0166682 A1
(43) Pub. Date: Jul. 19, 2007

(54) Medical training apparatus

(75) Inventors: Paul Yarin, Los Angeles, CA (US); Harrith M. Hasson, Albuquerque, NM (US); Amir Sharrett Hasson, Cambridge, MA (US)

Correspondence Address: WOOD, PHILLIPS, KATZ, CLARK & MORTIMER, 500 W. MADISON STREET, SUITE 3800, CHICAGO, IL, 60661, US

(73) Assignee: RealSim Systems, LLC.

(21) Appl. No.: 11/724,012

(22) Filed: Mar. 14, 2007

Related U.S. Application Data
(63) Continuation-in-part of application No. 10/349,420, filed on Jan. 22, 2003.
(60) Provisional application No. 60/794,425, filed on Apr. 24, 2006.

(51) Int. Cl. G09B 23/28

(52) U.S. Cl. 434/267; 434/262

(57) ABSTRACT

A self contained medical training apparatus comprises a portable case defining a work space simulating a body cavity and having a port to allow introduction of a medical instrument to the working space from externally of the working space. A carousel is rotationally mounted in the working space for rotating the carousel to select angular positions for performing a series of simulated medical procedures. A plurality of modules are mounted around a perimeter of the carousel. Each module comprises a different task upon which an associated medical procedure can be performed with a medical instrument. A plurality of sensors are each operatively associated with one of the modules for sensing progress of the associated medical procedure. A control unit is coupled to the sensors for monitoring progress of the medical procedures and providing an indication of status of the medical procedures.

### CROSS-REFERENCE

This application is a continuation-in-part of application Ser. No. 10/349,420 filed Jan. 22, 2003, and claims priority of application Ser. No. 60/794,425 filed Apr. 24, 2006.

### FIELD OF THE INVENTION

This invention relates to medical procedures, and, more particularly, to a training apparatus that can be used to practice medical procedures and provide feedback.

### BACKGROUND OF THE INVENTION

The performance of laparoscopy requires precise and controlled manipulation of medical instruments. Acquiring skills in video laparoscopy is time consuming and difficult. This is due to problems with orientation and hand-eye coordination associated with manipulating three dimensional objects that are viewed in a two dimensional format on a video monitor.

The learning curve in the operating room can be shortened by using training models. The models may be animate or inanimate. Animate models are realistic, but they require elaborate preparation, logistics and great expense. Further, because of humane considerations, training on animate objects is frowned upon. These factors contribute to the impracticality of using animate objects in training to perform laparoscopy. Inanimate training objects are commonly used. A number of these available trainers are cumbersome, unrealistic, ineffective and expensive. There are available models of human anatomy which, while lifelike, are expensive and may be usable only once to practice a particular procedure.

For training aids that have a fixed configuration, only limited movements and procedures may be practically carried out.

All of the above factors contribute to doctors often practicing less than is desirable for laparoscopy. This is particularly a problem given that laparoscopy is one of the more demanding types of surgery. Repetitive movements may be required to develop the dexterity and hand-eye coordination necessary for successful surgical outcomes.

Ideally, surgeons wish to have available to them a relatively inexpensive structure which is unobtrusive and which can be conveniently employed to allow surgeons, in their available time, to practice and perfect surgical skills. U.S. Pat. Nos. 5,873,732 and 5,947,743 disclose a physical laparoscopy training simulator which utilizes natural haptics to measure and develop laparoscopic skills. The simulator was comprised of a housing constructed with a multi-layered covering simulating the anterior abdominal wall and an adjustable floor mat suspended within the housing. The floor mat supported exercise models dedicated to specific laparoscopic skills. The models are viewed through a stand alone camera or a laparoscopy camera attached to a scope inserted through a cannula placed at the primary entry site. The scope is connected to a light source and the camera to a video monitor. Surgical manipulation of exercise models is carried out with standard laparoscopic tools directed from strategically located secondary points of entry. However, the referenced simulators do not provide for immediate user feedback and capture of performance data. Automated data capture makes the system well suited for controlled testing and performance qualifications.

### SUMMARY OF THE INVENTION

In accordance with the invention there is provided a medical training apparatus that provides an indication of the status of a medical procedure.

In accordance with one aspect of the invention there is disclosed a self contained medical training apparatus comprising a portable enclosure defining a work space simulating a body cavity and having an access port to allow introduction of a medical instrument to the working space from externally of the working space. A module is mounted in the working space upon which a medical procedure can be performed with a medical instrument. A sensor is operatively associated with the module for sensing progress of the medical procedure. A control unit in the enclosure is coupled to the sensor for monitoring progress of the medical procedure and providing an indication of status of the medical procedure.

In another form the medical training apparatus comprises a portable case defining a work space simulating a body cavity and having a port to allow introduction of a medical instrument to the working space from externally of the working space. A carousel is rotationally mounted in the working space for rotating the carousel to select angular positions for performing a series of simulated medical procedures. A plurality of modules are mounted around a perimeter of the carousel. Each module comprises a different task upon which an associated medical procedure can be performed with a medical instrument. A plurality of sensors are each operatively associated with one of the modules for sensing progress of the associated medical procedure. A control unit is coupled to the sensors for monitoring progress of the medical procedures and providing an indication of status of the medical procedures.

Further features and advantages of the invention will be readily apparent from the specification and from the drawings.

### BRIEF DESCRIPTION OF THE DRAWINGS

FIG. 1 is a perspective view of a stand alone version of a medical training apparatus in accordance with the invention;

FIG. 2 is a perspective view of the medical training apparatus of FIG. 1 connected to a personal computer;

FIG. 3 is a perspective view of a frame of the medical training apparatus of FIG. 1;

FIG. 4 is a top plan view of a rotary sensor platform of the medical training apparatus of FIG. 1;

FIG. 5 is a sectional view of the rotary sensor platform of FIG. 4 with parts removed for clarity;

FIG. 6 is a partial sectional view of a peg board model of the rotary sensor platform of FIG. 1;

FIG. 7 is a partial sectional view of a ring model of the rotary sensor platform of FIG. 4;

FIG. 8 is a partial sectional view of cannulation model of the rotary sensor platform of FIG. 4;

FIG. 9 is a perspective view of a knot tying model of the rotary sensor platform of FIG. 4;

FIG. 10 is a cutaway perspective view of a cable used on the knot tying model of FIG. 9;

FIG. 11 is a sectional view taken along the line 11-11 of FIG. 10;

FIG. 12 is a top plan view of a knot integrity model of the rotary sensor platform of FIG. 4;

FIG. 13 is a side elevation view of the knot tying model of FIG. 12;

FIG. 14 is a elevation view, similar to FIG. 13, with parts removed for clarity;

FIG. 15 is a plan view of a control panel of the medical training apparatus of FIG. 1;

FIG. 16 is a block diagram of a control unit for the medical training apparatus of FIG. 1;

FIGS. 17-19 are electrical schematics of sensor interface circuits of the control system of FIG. 16;

FIG. 20 is a flow diagram illustrating a program implemented in the microcontroller of FIG. 16;

FIG. 21 is a video monitor displayed displaying video from the camera with an overlay indicating status of a medical procedure, in accordance with the teachings of the invention;

FIG. 22 is a perspective view of a self-contained version of a medical training apparatus in accordance with another embodiment of the invention;

FIG. 23 is a series of views illustrating deployment of the medical training apparatus of FIG. 22 from a stowed configuration to an operational configuration;

FIG. 24 is a partial perspective view of a task mechanism carousel of the medical training apparatus of FIG. 22;

FIG. 25 is a partial perspective view illustrating an underside of the cover of the medical training apparatus of FIG. 22;

FIG. 26 is a block diagram of a controller unit for the medical training apparatus of FIG. 22;

FIG. 27 is a flow diagram illustrating software implemented in the computer system of FIG. 26;

FIG. 28 is a perspective view illustrating a peg manipulation task using the medical training apparatus of FIG. 22;

FIG. 29 is a perspective view illustrating a ring manipulation task using the medical training apparatus of FIG. 22;

FIG. 30 is a perspective view illustrating a cannulation task using the medical training apparatus of FIG. 22;

FIG. 31 is a perspective view illustrating a lasso loop knot preparation task using the medical training apparatus of FIG. 22;

FIG. 32 is a perspective view illustrating an intracorporeal knot cinching task using the medical training apparatus of FIG. 22;

FIG. 33 is a perspective view illustrating an extracorporeal knot tying task using the medical training apparatus of FIG. 22;

FIG. 34 is a perspective view illustrating an intracorporeal knot tying and knot integrity test using the medical training apparatus of FIG. 22;

FIG. 35 is a perspective view illustrating a cutting task using the medical training apparatus of FIG. 22;

FIG. 36 illustrates a screen display for a task selection interface;

FIG. 37 is a screen display illustrating task performance interface during use; and

FIG. 38 is a screen display illustrating report information provided by the medical training apparatus of FIG. 22.

### DETAILED DESCRIPTION OF THE INVENTION

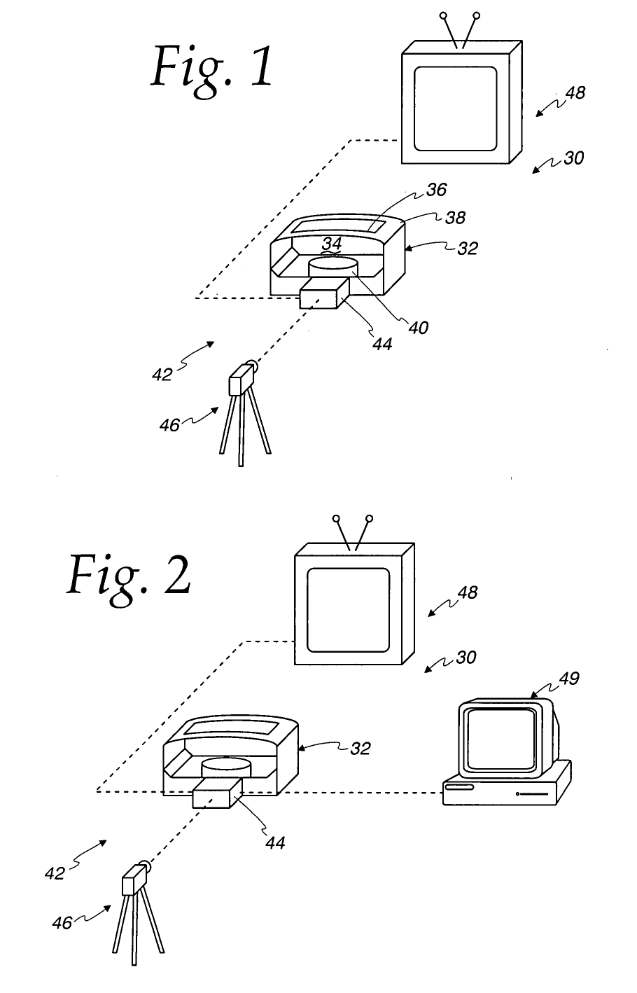

Referring initially to FIG. 1, a medical training apparatus 30 according to the present invention is illustrated. The training apparatus 30 consists of a frame 32 bounding a working space 34 which simulates a body cavity. The frame 32 is constructed so that the working space 34 has a general shape and dimensions of a distended human abdomen. An access opening 36 is provided through a top wall 38 of the frame 32 and defines a communication path from externally of the frame 32 to the working space 34 to allow introduction of a medical instrument to the working space 34 to simulate a laparoscopic procedure, as described below.

A rotary sensor platform 40 is rotationally mounted in the working space 34 for rotating the platform to select angular positions for performing a series of simulated medical procedures. As described below, the rotary sensor platform 40 supports a plurality of modules each comprising a different model upon which an associated medical procedure can be performed. Sensors are associated with each of the modules. A control unit or system 42 is coupled to the sensors for monitoring progress of the medical procedure and providing an indication of status of the medical procedure. The control system 42 comprises a control panel 44, a video camera 46 and a video monitor 48. The video camera 46 and video monitor 48 are electrically connected to the control panel 44,as described more specifically below.

FIG. 2 illustrates an alternative embodiment of the medical training apparatus 30 in which the control unit 42 further comprises a personal computer 49 electrically connected to the control panel 44.

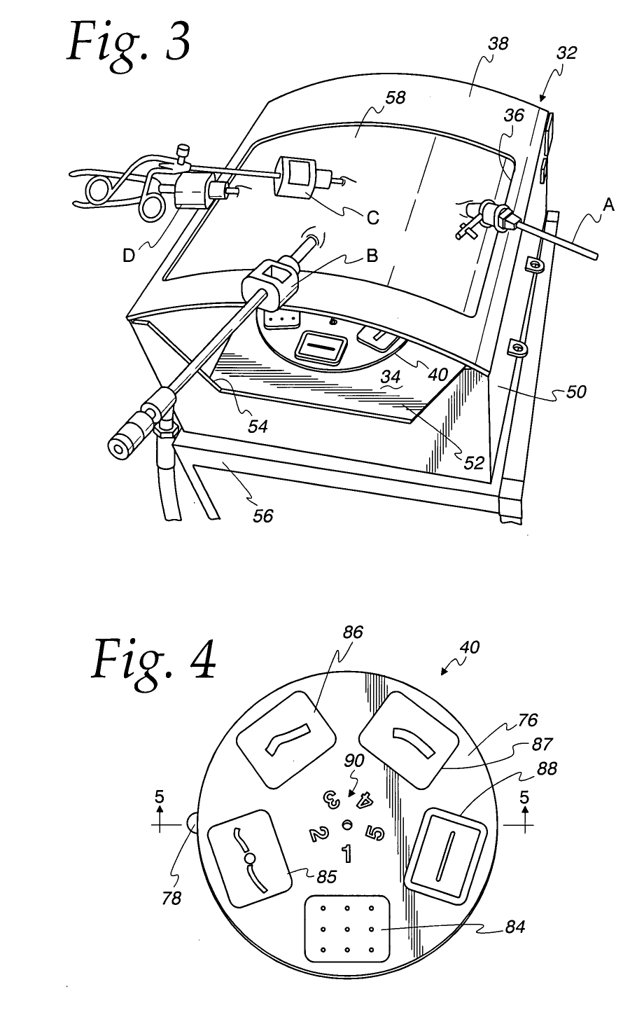

Referring to FIG. 3, the frame 32 is illustrated in greater detail. The frame 32 may be as generally described in U.S. Pat. Nos. 5,873,732 and 5,947,743, the specifications of which are hereby incorporated by reference herein.

In addition to the top wall 38, the frame 32 comprises a perimeter sidewall 50 connected to the top wall 38 and a bottom wall 52 to define the working space 34. The sidewall 50 includes an end wall opening 54 providing access to the working space 34. The frame 32 may be mounted on a table or supported by a cart 56, as necessary or desired.

To simulate human tissue, a membrane layer 58 is placed over the access opening 36. The membrane layer 58 may be, for example, a flexible, cloth membrane layer, as described in the referenced patents. An operator can direct medical instruments, such as instruments A, B, C and D through the membrane layer 58 from externally of the working space 14 to within the working space 34. The instruments A-D are inserted through suitable openings provided in the membrane layer 58. The membrane layer 58 preferably has a thickness and texture to produce the flexibility of human tissue so that the operator has the same sensation as existing during an actual operation. In one form, three layers of rubber, sponge and/or latex are used to define the membrane layer 58.

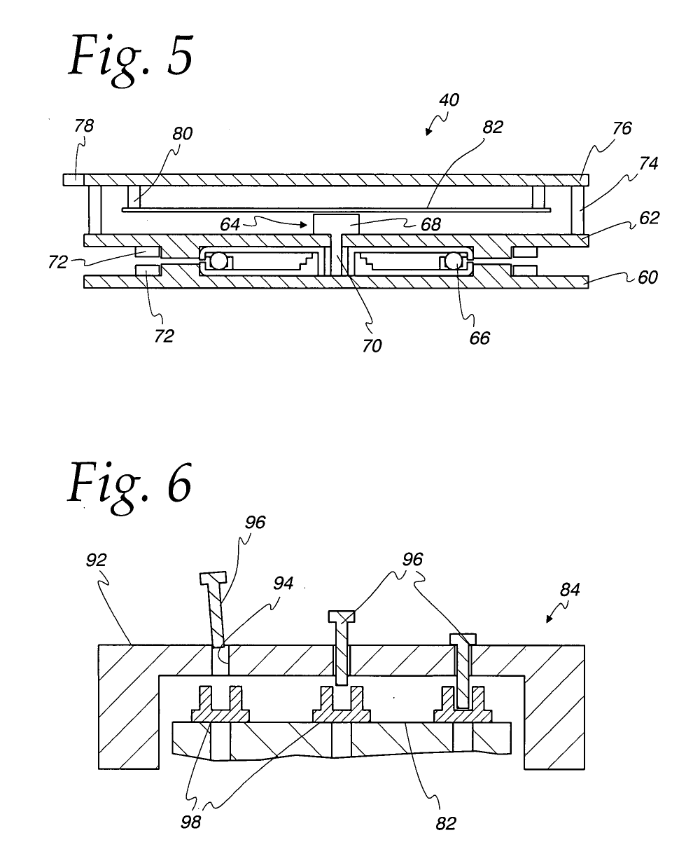

Referring to FIGS. 4 and 5, the sensor platform 40 is illustrated. The sensor platform 40 may comprise a rotating 12 inch circular acrylic carousel that attaches to the inside of the frame 32. More particularly, the sensor platform 40 comprises a carousel base 60 supporting a platform 62 via a rotary potentiometer 64. A bearing mechanism 66 is disposed between the base 60 and platform 62 for facilitating rotation. Particularly, the potentiometer 64 includes a fixed resistive element 68 mounted to the platform 62 and a rotary shaft 70 extending therefrom operatively connected to the base 60. The sensor platform 40 is mounted in the working space 34 with the base 60 affixed thereto. As is apparent, rotation of the platform 62 relative to the base 60 changes resistance of the potentiometer 64. The resistance of the potentiometer 64 is used to detect angular position of the sensor platform 40. Additionally, the sensor platform 40 has detent magnets 72 that allow it to “lock” into each of five desired positions with some tension.

A plurality of supports 74 mount a carousel cover 76 to the carousel platform 62. The carousel cover is generally circular and in the illustrated embodiment of the invention is approximately 12 inches in diameter. A finger tab 78 at one edge can be used to manually rotate the cover 76 relative to the base 60.

A plurality of printed circuit board supports 80 extend downwardly from the cover 76 and support a sensor printed circuit board 82. Although not shown, leads of the potentiometer resistive element 68 are electrically connected to the printed circuit board 82.

Referring particularly to FIG. 4, the carousel cover 76 supports five modules 84, 85, 86, 87 and 88 around its perimeter. Each module 84-88 comprises a different model upon which an associated medical procedure can be performed with a medical instrument, such as instruments A-D of FIG. 3. An operator can switch among tasks by turning the carousel cover 76 using the finger tab 78 to the next module 84, 85, 86, 87 or 88, which are represented by numerals 90 molded on the cover 76, as shown in FIG. 4.

In accordance with the invention, the sensor platform 40 has five task modules. The first is a peg module 84 used to detect insertion of pegs into a grid of nine holes. Holes are spaced about 10 mm apart. The second module 85 consists of a ring module having bent wire forms onto which O-rings can be threaded. The third module 86 comprises a cannulation module. The fourth module 87 consists of a knot tying module. The fifth module 88 consists of a knot integrity test module.

Referring also to FIG. 6, the peg module 84 is illustrated in greater detail. The peg module comprises a base plate 92 which may comprise the carousel cover 76. The base plate 92 includes nine through openings 94 through which pegs 96 can be inserted. An array of photointerrupters 98 are mounted to the printed circuit board 82. Each photointerruptor 98 consists of an infrared emitter and detector mounted in a single housing and separated by an open slot. Any object that blocks the line of sight connection causes a drop in the current output by the detector. Alternatively, the pegs 96 could be detected using inductive coils around each peg opening 94. The inductive coils would be connected to an inductive bridge circuit.

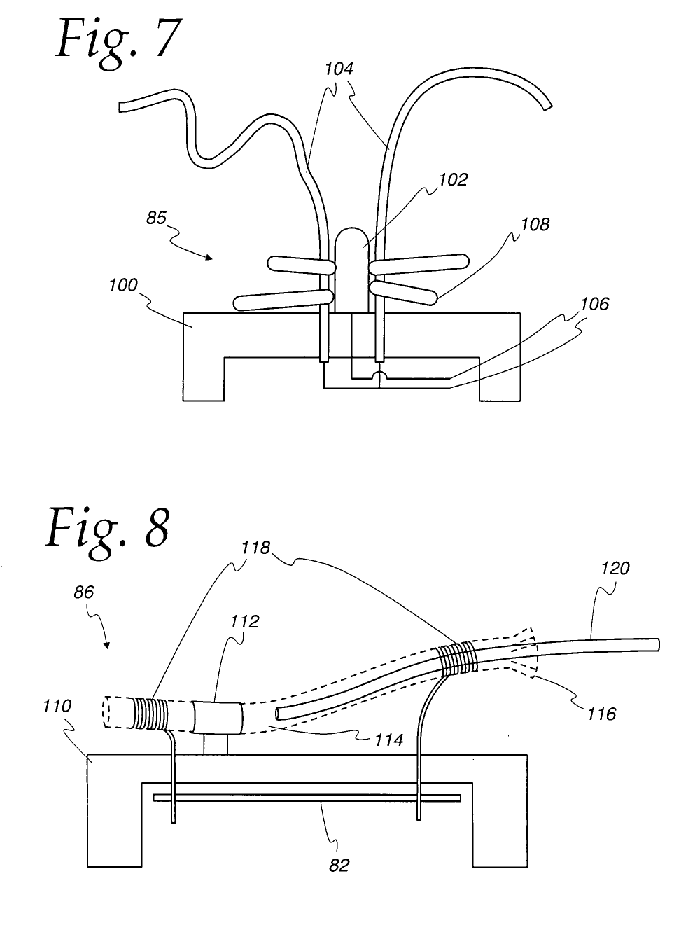

Referring to FIG. 7, the ring module 85 includes an insulated base plate 100 which may comprise the carousel cover 76. A conductive steel post 102 extends upwardly from the base plate. Bent wire forms 104 extend upwardly from the base plate 100 on either side of the conductive post 102. Leads 106 from the conductive post 102 and the bent wire forms 104 provide a resistance measuring point. The bent wire forms 104 are bent into curved shapes. Conductive rubber O-rings 108 are looped over the bent wire forms 104. In this module 85 a total of four rings 108 must be threaded to the base of the wire forms 104. The use of electrically conductive rubber O-rings provides for a resistance or conductivity measurement using the leads 106. As such, resistance between the metallic post 102 and the two wire forms 104 is measured. The conductive post 102 is positioned such that only a small gap separates it from each wire form 104. As the O-rings 108 are pushed down the wire forms 104 it is squeezed into the gap between the post 102 and the wire forms 104. Each additional O-ring 108 will lower the resistance measured at the leads 106. When the resistance falls below a certain value, then task completion is detected. An alternative approach would be to detect the presence of each O-ring 108 with an optical sensor.

Referring to FIG. 8, the cannulation module 86 is illustrated. The cannulation module 86 includes a base plate 110 which may comprise the carousel cover 76. A clamp 112 extends upwardly from the base plate 110 and supports a clear plastic tube 114 having a flared end 116. Inductive windings 118 are placed near each end of the tube 114. Ends of the windings 118 are connected to the printed circuit board 82. To perform the cannulation task, an operator inserts an elongate element 120, such as a standard pipe cleaner, through the section of clear plastic tubing 114. The element 120 can be extracted from the opposite end. By measuring the change in inductance at each end, the introduction of the metallic core of the pipe cleaner 120 can be detected. At least two detectors are necessary to determine that the pipe cleaner 120 has actually passed through the tube 114. Alternatively, an optical reflectance or photo-interruption measurement could be used.

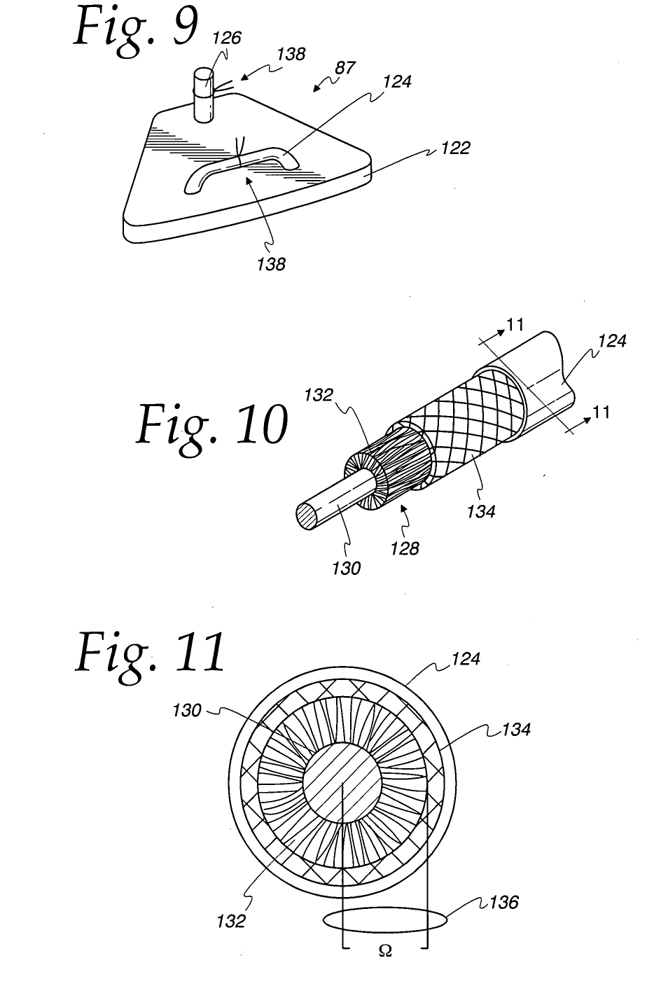

Referring to FIG. 9, the knot tying module 87 is illustrated. The knot tying module 87 comprises a base plate 122 which may comprise the carousel cover 76. The base plate 122 supports a horizontally oriented tubular element 124 and a vertically oriented tubular element 126. FIGS. 10 and 11 illustrate a portion of the horizontal tubular element 124 which encloses a coaxial cable 128. Each of the tubular elements 124 and 126 enclose such a cable 128. Particularly, the coaxial cable 128 includes a conductive rod core 130 surrounded by a conductive foam 132 which is in turn surrounded by a metal braid 134 enclosed within the tubing element 124. As illustrated in FIG. 11, leads 136 can be electrically connected to the rod core 130 and metal braid 134 to measure resistance or conductivity between the core 130 and the braid 134. The leads 136 are to be electrically connected to the printed circuit board 82, see FIG. 5. Particularly, as a knot 138 is tied around either tubular element 124 or 126, see FIG. 9, the conductive foam is compressed so that the wire braid 134 is closer to the rod core 130 to decrease resistance. The resistance will be monitored to determine the level of deformation exacted by the cinching of the knot 138 around one of the tubular elements 126 and 124.

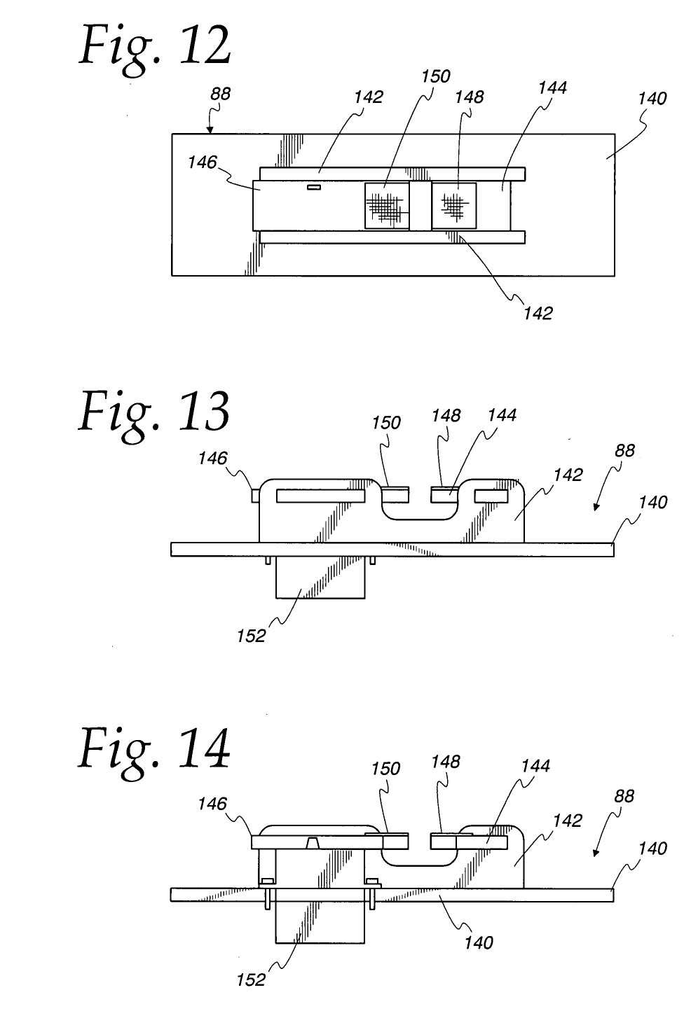

Referring to FIGS. 12-14, the knot integrity test module 88 is illustrated. The module includes a base plate 140 which may comprise the carousel cover 76. A pair of plate track and supports 142 extend upwardly from the base plate 140 for supporting a fixed plate 144 and a moveable plate 146. A piece of nylon webbing 148 is secured to the fixed plate 144. A second piece of nylon webbing 150 is secured to the moveable plate 146. A servo motor 152 is fixedly mounted to the base plate 140 and is operatively connected to the moveable plate 146 to drive the same linearly back and forth, i.e., towards and away from the fixed plate 144. The servo motor 152 is electrically connected to the printed circuit board 82, see FIG. 5, in a conventional manner. The operator will complete a suturing task across the nylon webbing 148 and 150. Upon completion of the task, determined by the operator pressing a button, the moveable plate 146 is moved away from the fixed plate 144 with a force of at least two pounds. A proper knot provides a stress which prevents displacement by the servo motor 152. Thus, servo motor displacement can be used to sense if the knot slips or has been maintained.

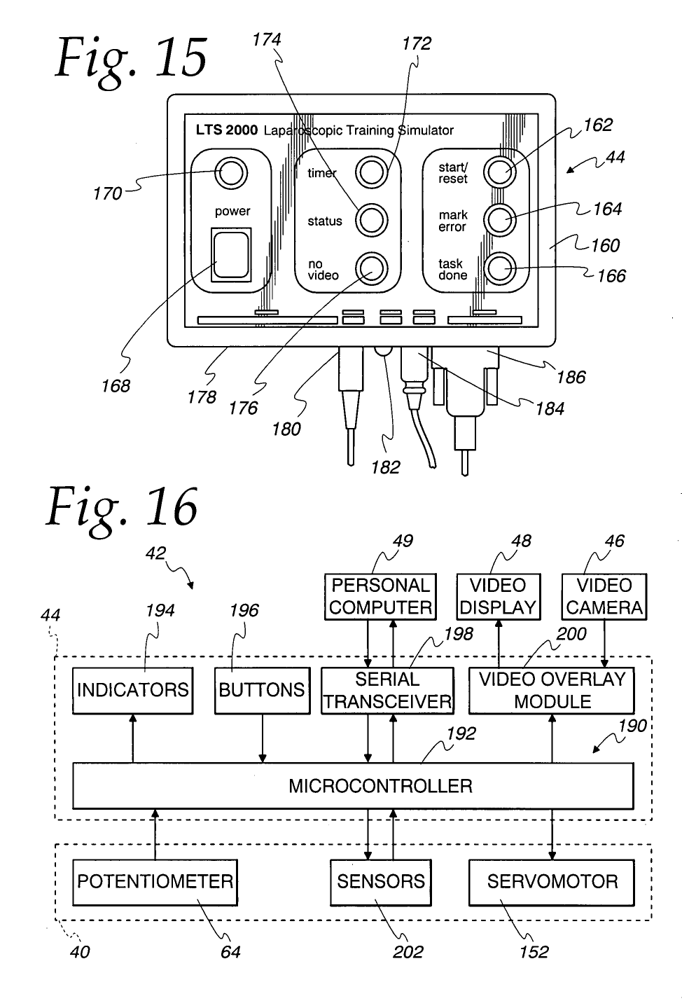

Referring to FIG. 15, the control panel 44 comprises a system controller in a rectangular enclosure 160 that can be affixed to the front face of the frame 32. The enclosure 160 supports a start/reset button 162 to start or reset a given task; a mark error button 164 to allow undetected errors, such as dropping a peg 96, to be logged; and a task done button 166 to mark completion of a task. A power switch 168 is used for turning the system controller 44 on or off which is indicated by a power LED 170. Additionally, the enclosure 160 supports a timer LED 172 that flashes while a timer is running, a status LED 174 is used to indicate the system is ready and also error messages, and a no video LED 176 is illuminated when input video is missing.

A bottom edge of the enclosure 160 includes a sensor data bus connector 178, a power input 180, a composite video input 182, composite video out 184 and an RS232 serial data port 186.

Referring to FIG. 16, a block diagram of the control system 42 is illustrated. The system controller 44 includes a control circuit 190 having a microcontroller 192. The microcontroller 192 is connected to indicators 194, including the LEDs 170, 172, 174 and 176, see FIG. 15, and buttons 196, including push buttons 162, 164 and 166. The microcontroller 192 is optionally connected to the personal computer 49 via an RS232 serial transceiver circuit 198. The microcontroller 192 is connected to a video overlay module 200. The video camera 46 and video display 48 are in turn connected to the video overlay module 200. The microcontroller 192 is also connected via the sensor data bus connection 178 to the printed circuit board 82 of the sensor platform 40. Particularly, the microcontroller 192 is electrically connected to the platform potentiometer 64, see FIG. 5, to the servo motor 152, see FIG. 14, and sensors 202. The sensors 202 include the various sensing elements monitored by the printed circuit board 82 as shown in FIG. 6-11 and discussed above.

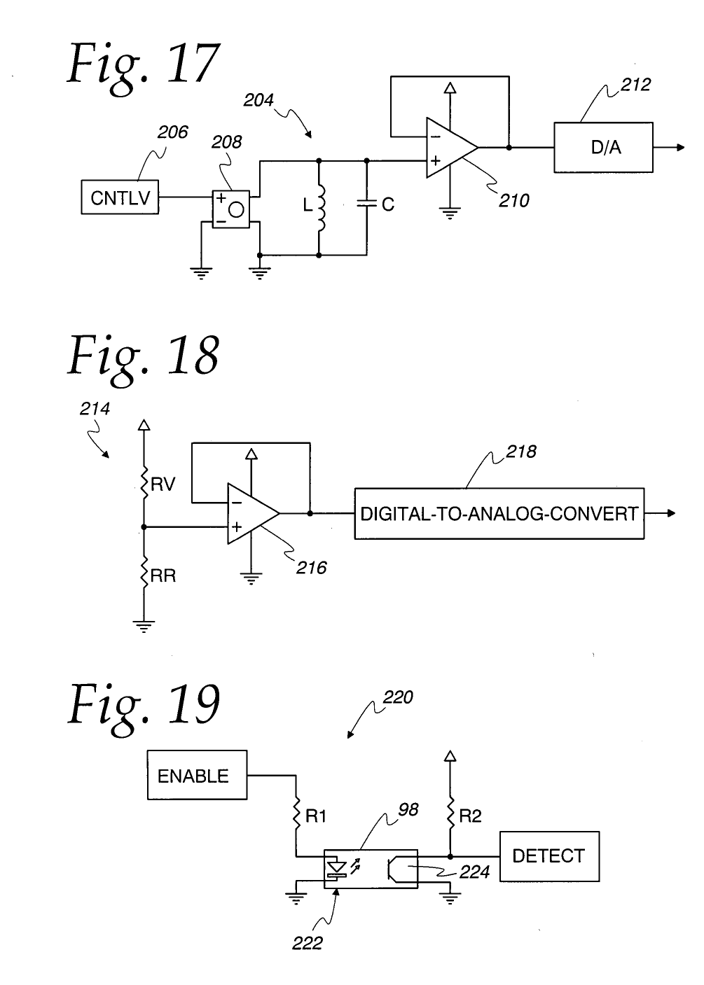

FIGS. 17-19 comprise electrical schematics illustrating interface circuits between the various sensor devices and the microcontroller 192. These circuits may be included on the printed circuit board 82 or the control circuit 190. FIG. 17 illustrates an inductance measurement circuit 204. A control voltage 206 from the microcontroller 192 is supplied to a voltage controlled oscillator 208. Connected across the voltage controlled oscillator 208 are a variable inductor L and a capacitor C. The inductor L represents an inductance being measured, such as one of the inductors 118 of FIG. 8. One side of the oscillator output is connected to ground. The other side is connected to the non-inverted input of an operational amplifier 210. The output of the operational amplifier 210 is connected as feedback to the inverted input and to a digital to analog (D/A) convertor 212 which provides an inductance value to the microcontroller 192.

FIG. 18 illustrates a conductance or resistance measurement circuit to 14. The resistance measurement circuit includes a voltage divider formed by a variable resistor RV and a reference resistor RR. The variable resistor RV represents the resistance being sensed, such as resistance across the leads 106 in FIG. 7 or resistance across the lines 136, see FIG. 11. The junction between the resistors RV and RR is connected to the non-inverted input of an operational amplifier 216. The output of the operational amplifier 216 is connected as feedback to the inverted input and is supplied to a D to A convertor 218 which provides a resistance value to the microcontroller 192.

FIG. 19 illustrates an electrical schematic for a photointerruptor circuit 220. An enable output for the microcontroller 192 is connected via a resistor RI to an LED 222 of the photointerruptor 98. A detector 224 of the photointerruptor 98 is connected via a resister R2 to voltage supply and to a detect input of the microcontroller 192.

The microcontroller 192 contains software and firmware to allow basic operation of the medical training apparatus 30 with the video monitor 48 as the display and a further indicator. The video overlay module 200, such as a BOB-3 module from Decade Engineering, generates a video overlay signal based on serial text data received from the microcontroller 192.

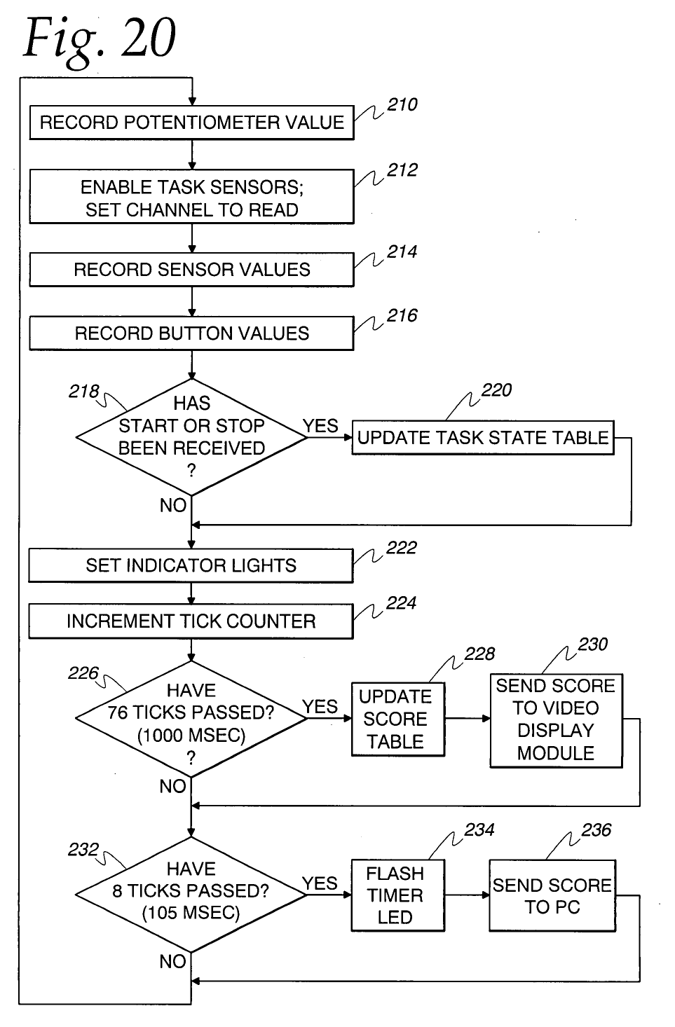

Referring to FIG. 20, a flow diagram illustrates a program implemented by the microcontroller 192 of FIG. 16 during operation. As is apparent, this operation would be implemented subsequent to start up during normal operation of the device.

The flow diagram begins at a block 210 which records a potentiometer value from the sensor platform potentiometer 64 representing angular position of the sensor platform. This is used to determine which of the five tasks is to be performed. A block 212 then enables the appropriate task sensors and sets the appropriate channels to be read. A block 214 records sensor values and a block 216 records button values for any control panel buttons 196 pressed by the operator.

A decision block 218 determines if a start or stop command has been received as by depressing the start button 162 or the task done button 166, see FIG. 15. If so, then a block 220 updates a task state table. Thereafter, or if not, then a block 222 sets the indicator lights 194 as appropriate for the state of operation. A block 224 increments a tick counter used to time the various surgical tasks. A decision block 226 determines if 76 ticks (representing 1,000 milliseconds) have passed. If so, then a score table is updated at a block 228 and the score is sent to the video overlay module 200 at a block 230. Thereafter, or if 76 ticks have not passed, as determined at the decision block 226, then a decision block 232 determines if eight ticks (representing 105 milliseconds) have passed. If so, then the timer LED 172, see FIG. 15, is flashed at a block 234. The current score is sent to the personal computer 49 at a block 236. Thereafter, or if eight ticks have not passed, then control returns back to the block 210 to repeat the process.

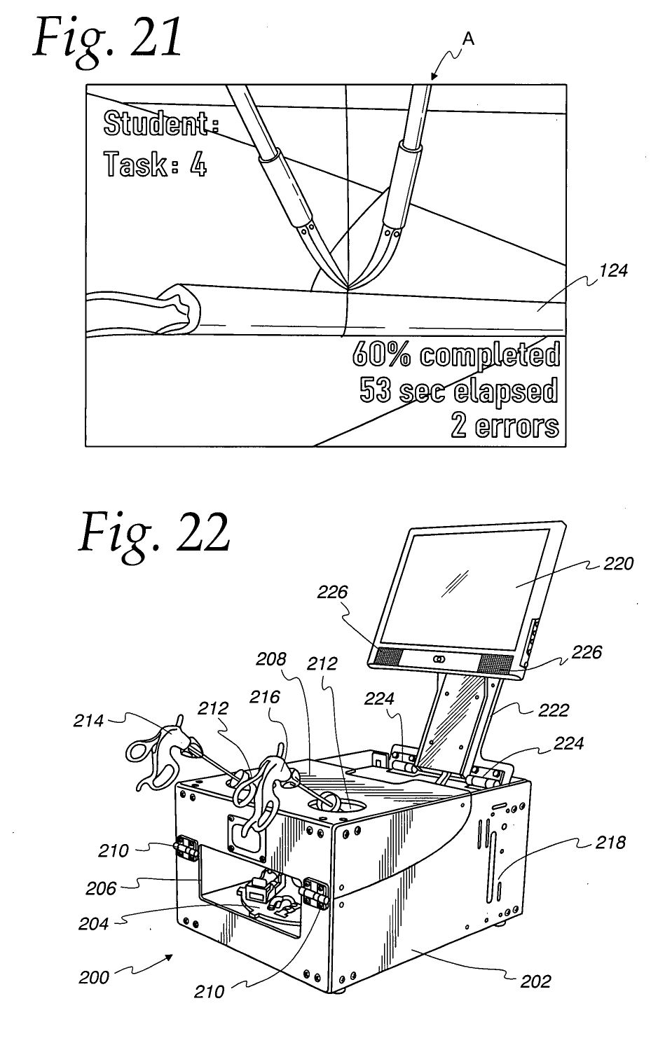

As such, the control program continually records status of the medical procedure being performed and provides an indication of the status. The status is indicated via the LEDs 172, 174 and 176, as well as using the video monitor 48. Particularly, FIG. 21 illustrates a screen display on the video monitor 48 during the knot tying task. The monitor shows the image being recorded by the camera 46. In this instance, the camera is recording the tying of a knot about the horizontal tubular element 124, using an instrument, for example the instrument A. Overlayed on the video display is identification of the operator, the task number, the percent of completion of the task, the elapsed time and the number of errors sensed. The overlay information is provided by the microcontroller 192 in response to information from the sensors 202 and provided to the video overlay module 200 which overlays it on the captured image.

Referring to FIG. 22, a medical training system or apparatus 200 according to another embodiment of the invention is illustrated. The apparatus 200 comprises a self-contained apparatus for the structured testing and training of skills used in laparoscopic surgery. The apparatus 200 includes a set of skill and coordination exercises performed using standard laparoscopic instruments. Each exercise requires manipulation of physical mechanisms with integrated electronic sensors. The effectors of the instruments and the task mechanism are viewed on a computer display that displays the output of a camera within the apparatus 200. Performance on the task is measured by an electronic timer and by sensors incorporated into the task mechanisms. Based upon scoring rules, a test administrator can record additional notes on task performance. An objective, quantitative score is generated that represents the degree of skill demonstrated in the performance of each task.

Compared to the apparatus 30, discussed above, the self-contained apparatus 200 adds a cutting task and uses alternative ring, knot tying and cannulation tasks on the carousel, uses alternative sensing techniques, and integrates a personal computer, display and digital video camera and enhanced software for recording and review of video.

The apparatus 200 includes an enclosure in the form of a case 202 defining a working space 202S simulating a body cavity, as above, that houses an alternative sensor platform in the form of a revolving task mechanism carousel 204 visible through an opening 206. A folding cover 208 is hingedly mounted to the enclosure 202 using hinges 210. The cover 208 covers the carousel 204 and includes two laparoscopic instrument access ports 212. As is apparent, additional access ports could be provided. Laparoscopic instruments 214 and 216 are insertable through the ports 212 and are used to perform operations upon sensors, described below, mounted on the carousel 204.

The enclosure 202 houses a computer 218. An electronic display 220 is mounted on a folding arm 222 hingedly mounted to the enclosure 202 using hinges 224. The video display 220 may comprise a touch screen panel. A separate keyboard can be removed from a storage slot and affixed atop the cover 208 and be operatively connected to the computer 218. Audio speakers 226 are integrated into the display device 220.

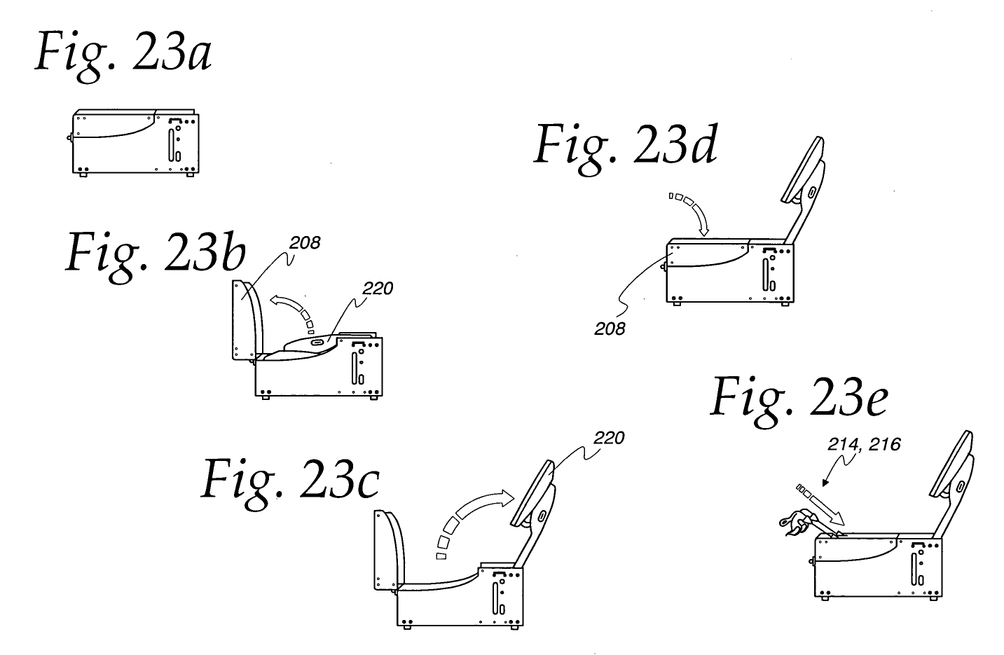

As described, the video display 220 is mounted to hinges 224 that permit adjustment of viewing angle and storage within the enclosure 202. FIG. 23 comprises a series of images illustrating a deployment sequence, with image 1 illustrating a stowed configuration. In the stowed configuration, the apparatus 200 is portable, much like a suitcase, and can be hand carried. Image 2 illustrates the cover 208 open and the display 220 in the stowed position. Image 3 illustrates moving the display 220 to the extended position. Image 4 illustrates the cover 208 returned to the closed position. Finally, image 5 illustrates instruments 214 and 216 being inserted into the ports 212 for testing.

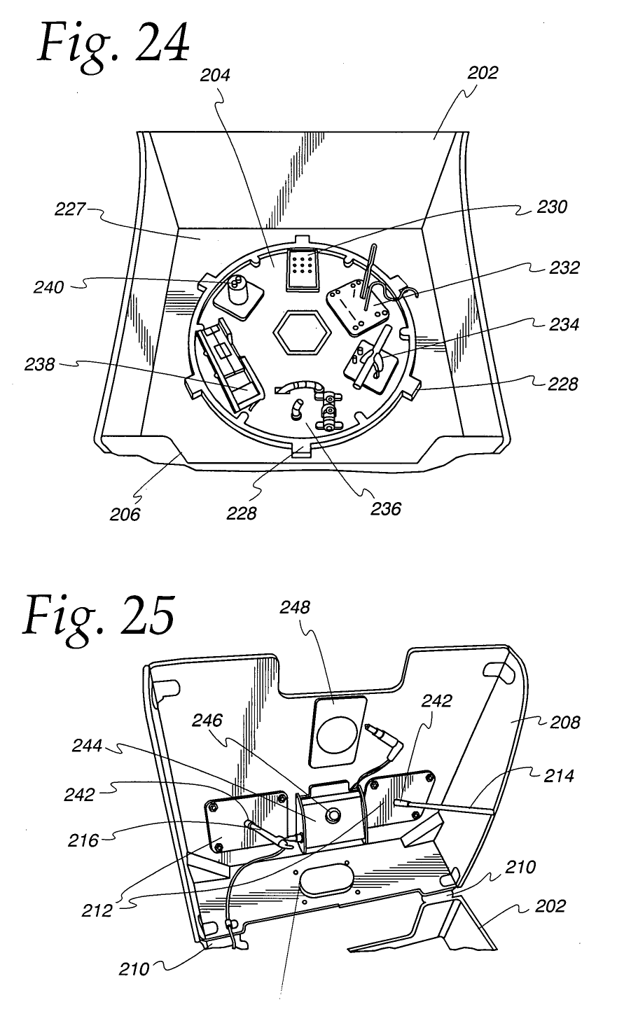

FIG. 24 illustrates the task mechanism carousel 204 housed in the enclosure 202, with the cover and other components removed for clarity of illustration. The carousel 204 is supported above a support floor 227 in the enclosure 202. The carousel is rotated manually by means of finger tabs 228 spaced circumferentially about the carousel 204. As it is rotated, the carousel 204 locks into position at angular intervals corresponding to positions of the task mechanisms, described below, and the finger tabs 228. Sensing of position of the carousel 204 may be as described above relative to the sensor platform 40. Likewise, printed circuit boards for the various sensors may be provided underneath the carousel 204, as discussed above.

The carousel 204 includes six task modules. These include a peg manipulation task module 230, a ring manipulation task module 232, a cannulation task module 234, a knot tying task module 236, a knot integrity task module 238, and a cutting task module 240.

FIG. 25 illustrates in perspective view an underside of the cover 208 in the open position. The folding cover 208 comprises the two instrument ports 212, shown with the instruments 214 and 216 inserted therethrough. A flexible material surrounds these ports and provides compliance for the instruments. In typical use, the cover 208 is closed and a retention latch (not shown) is engaged. The two standard laparoscopic cannula 242 are inserted through the instrument ports 212, with the instruments 214 and 216 inserted through the cannula 242.

A video camera 244 is mounted to the cover 208 between the ports 212. The camera includes a lens 246 directed toward a distal edge of the carousel 204, opposite the opening 206. An illuminator 248 is positioned on the underside of the cover 208 to illuminate the task module for the camera 244. Rotating the carousel 204 brings a single task module into the camera's field of view. An angular sensor mounted on the carousel 204, as discussed above, transmits the carousel position to the computer 218.

The video camera 244 employs a charged couple device sensor or complementary metal-oxide (CMOS) sensor and a fixed lens. The video camera uses a high speed serial interface to send image data to the computer 218. The illuminator 248 is a white light source comprised of an array of light emitting diodes. The use of an array of multiple lamps creates a diffused light source with fewer visible shadows.

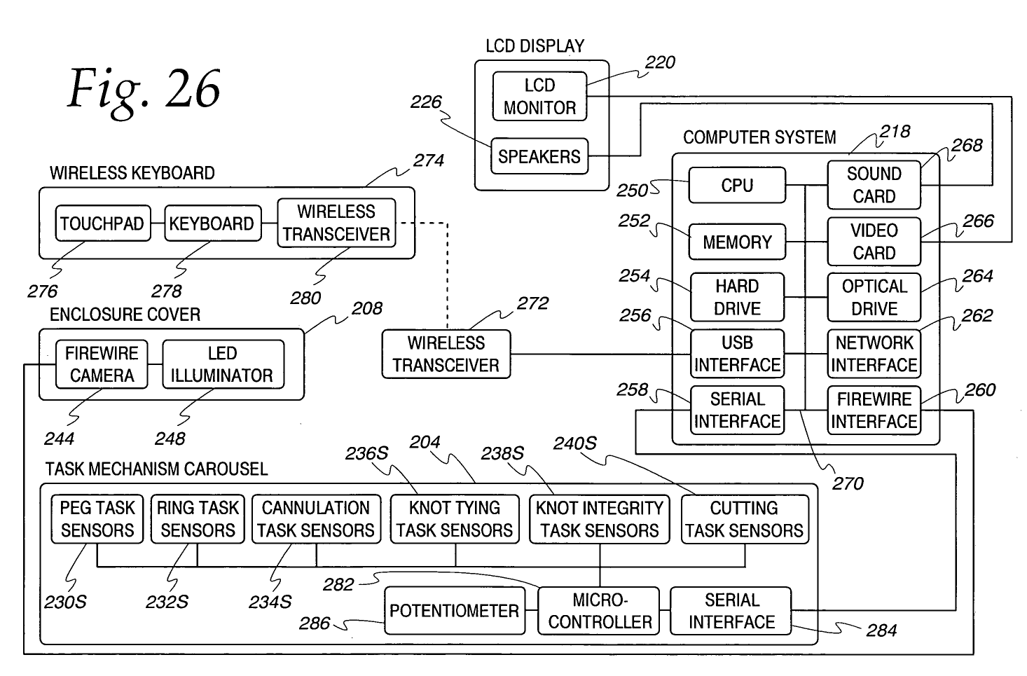

FIG. 26 comprises a block diagram of the medical training apparatus 200. The computer 218 comprises generally conventional components such as a CPU 250, a memory 252, a hard drive 254, a USB interface 256, a serial interface 258, a firewire interface 260, a network interface 262, an optical drive 264, a video card 266 and a sound card 268 all interconnected via a bus 270. The speakers 226 are driven by the sound card 268. The monitor 220 is driven by the video card 226. The firewire interface 260 is connected to the camera 244 and the illuminator 248. The USB interface 256 is connected to a wireless transceiver 272 for connection to a wireless keyboard 274. The keyboard 274 includes a touch pad 276, keyboard 278 and wireless transceiver 280. As is apparent, a wired keyboard could also be used.

The task mechanism carousel uses a control circuit comprising a microcontroller 282 operatively connected to a serial interface 284 for communication with the computer system 218 via the serial interface 258. The microcontroller 282 provides an interface to the sensors on the carousel 204, including a potentiometer 286 for sensing angular position of the carousel 204. The microcontroller 282 is also connected to sensors associated with the individual modules, as follows:

| Module | Sensors |
|---|---|
| Peg Task Module 230 | Peg Task Sensor 230S |
| Ring Task Module 232 | Ring Task Sensor 232S |
| Knot Tying Task Module 236 | Knot Tying Task Sensor 236S |
| Cannulation Task Module 234 | Cannulation Task Sensor 234S |
| Knot Integrity Task Module 238 | Knot Integrity Task Sensor 238S |
| Cutting Task Module 240 | Cutting Task Sensor 240S |

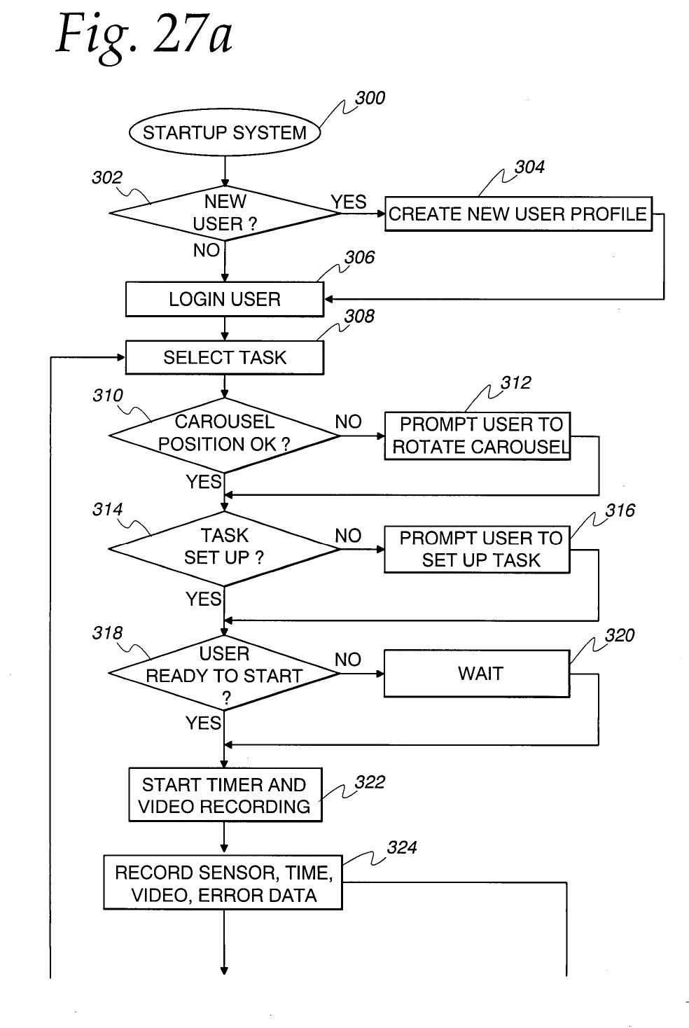

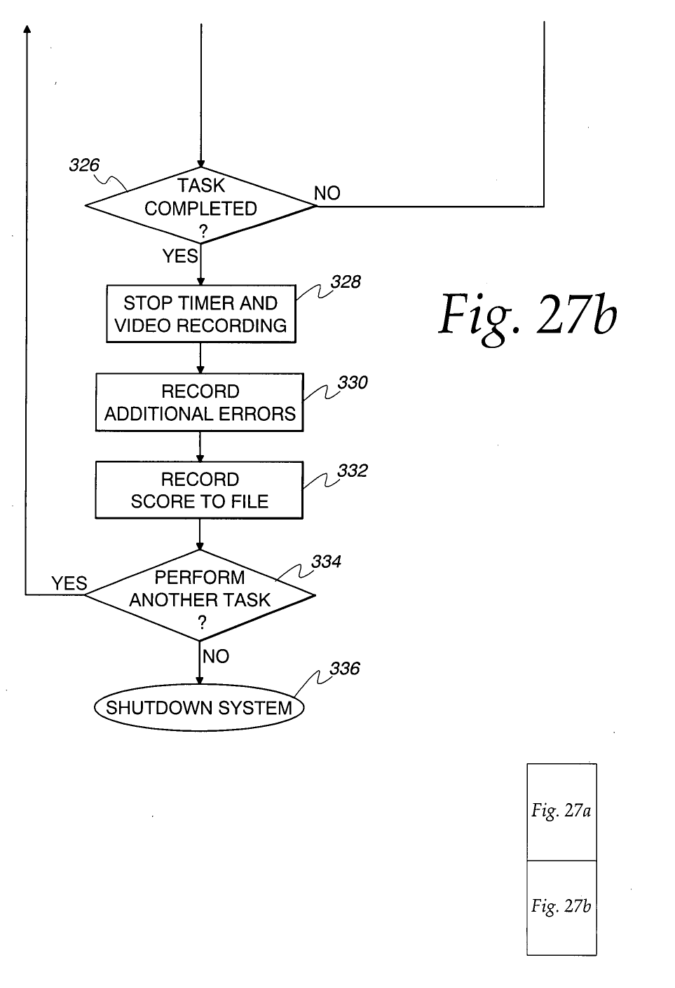

FIG. 27 is a flow diagram illustrating operation of a software program operated by the computer system 218. The program begins at a start-up system node 300 when the apparatus 200 is turned on and subsequent to boot up and general initialization. A decision block 302 determines if the apparatus is being used by a new user. If so, then the user is prompted to create a new user profile at a block 304. Thereafter, or if there is not a new user, then the user logs in at a block 306. A block 308 allows for the user to select a task. A decision block 310 determines if the carousel is in proper position for the selected task. If not, then the user is prompted to rotate the carousel 204 at a block 312. Subsequently, a decision block 314 determines if the task is set up as by having the appropriate pieces in the necessary locations, as discussed below. If not, then the user is prompted to set up the task at a block 316. Next, a decision block 318 determines if the user is ready to start. The system waits at a block 320 until the user has initiated a start operation.

Once the user is ready to start, then a timer is started at a block 322. Simultaneously, video recording with the camera 244 begins. A decision block 324 records sensor status, time, video and error data and stores the information in the memory 252 or hard drive 254. A decision block 326 determines if the task has been completed. If not, then the program loops back to the block 324 until the task is completed. Once the task is completed, then the timer is stopped and video recording is stopped at a block 328. Any additional errors are recorded at a block 330. The score is recorded to file at a block 332. A decision block 334 determines if another task is to be performed. If so, then the program returns to the block 308 to select another task. If not, then the system is shut down at a node 336.

The apparatus 200 uses various supplies to perform the tasks. These are described below in connection with the specific task modules. The supplies include metallic pegs, conductive rubber rings, a flexible metallic rod, a pair of flexible tubes, a length of suturing thread, a curved needle and suture and a paper cutting disk. Also, standard laparoscopic instruments may be used with the apparatus 200 such as, for example, port cannulas, grasping alligator forceps, a needle driver, a knot pusher, a hemostat, and a curved scissors.

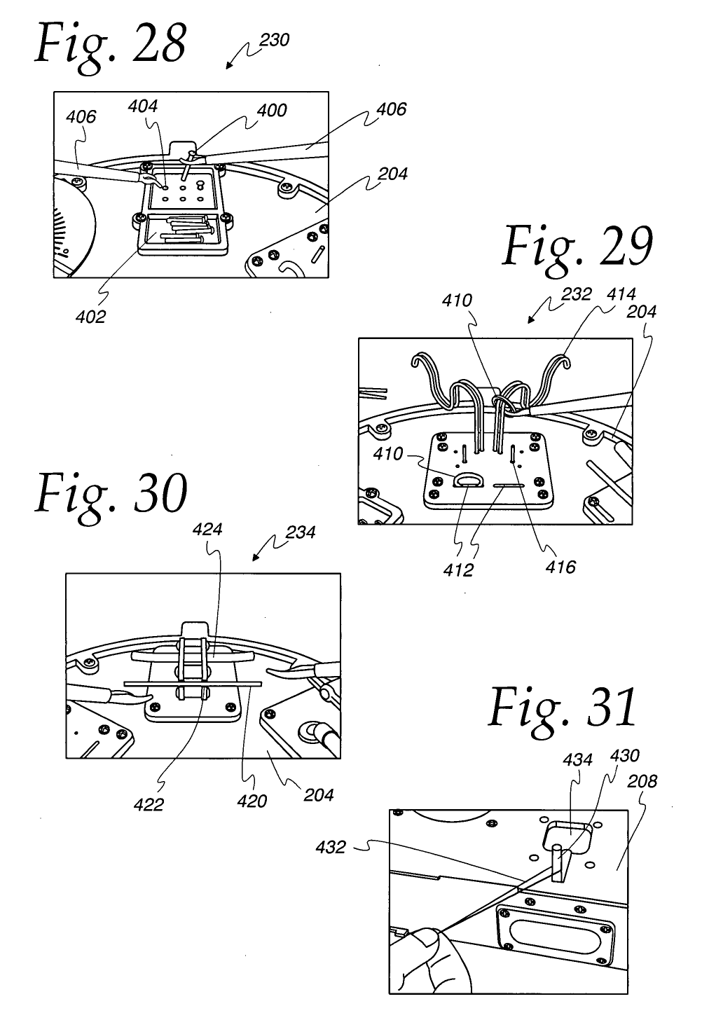

FIG. 28 illustrates a peg manipulation task using the module 230. This task measures the ability to dexterously manipulate and position small objects. Rigid pegs 400 must be picked up from a storage tray 402 and placed into target holes 404. The user operates two laparoscopic forceps instruments 406 with both hands concurrently. The pegs 400 are detected by the peg task sensors 230S, see FIG. 26, which may comprise photo interrupter sensors located beneath the carousel 204. Prior to peg insertion, an infrared beam strikes a photo detector located across an air gap. When the peg 400 is inserted in a target hole 404, it blocks the beam, producing change in the electrical outlet of the photo detector. The photo detector may be similar to that described above relative to FIG. 19. The pegs 400 can be constructed from a wide variety of materials, provided that they are rigid and opaque.

FIG. 29 illustrates the task mechanism for a ring manipulation task using the module 232. This task measures the ability to manipulate small objects continuously with both dominant and non-dominant hands independently. A flexible ring 410 is picked up from a storage slot 412 and is looped over the end of a wire guide 414. The ring 410 is maneuvered down the contour of the wire guide 414 towards its base. Contact made with the wire guide 414 is recorded as an error. At the base of the wire guide 414 the ring 410 is looped around a peg 416. This action concludes the task. The user performs this task twice, once with the dominant hand on the wire guide 414 corresponding to the dominant side for the user and again with the non-dominant hand on the opposite side.

The ring task sensor 232S, see FIG. 26, may use one of two distinct approaches. The first uses conductivity sensing. The ring 410 is detected by sensing current it conducts between two electrodes forming the wire guide 414. Particularly, each wire guide 414 is formed of two identical, metallic guide elements mounted in parallel, as shown. A non-conductive spacer (not shown) separates ends of the two wire guide elements. The rings are molded or stamped from a highly conductive flexible material. The first guide element is held at an elevated voltage and voltage on the other guide element is measured continuously. When the ring 410 makes contact with both wire guide elements in unison, it raises the voltage of the second guide element. This signal is used to detect the error condition of bumping the ring 410 against the two guide elements. After the ring 410 is moved to the base of the guide, it is looped around the vertical post 416. The vertical post is also electrically isolated and its voltage measured continuously. The looping of the ring 410 can thus be detected electronically.

In another approach, the ring task sensor 232S uses capacitive sensing as the contact of the ring 410 is detected by measuring capacitance of the contact electrodes. Each of the two wire guides 414 consist of a single conductive electrode. The capacitance of the wire guide is measured continuously through a cyclic discharge technique. When the ring 410 contacts the wire guide 414, it increases the measured capacitance as it couples both itself and the metallic laparoscopic instrument to the wire guide 414. Similarly, when the ring 410 comes in contact with the vertical post 416, it produces a measurable change in capacitance upon the wire guide 414. The capacitive technique has several advantages. As the ring material conducts very little current, it can be produced from a material with a higher contact and volumetric resistance. This permits use of more durable, less expensive materials, such as carbon-impregnated rubbers, rather than silver- or nickle-impregnated rubbers. The single electrode wire guide can be manufactured more readily than a pair of two guide elements in parallel. Finally, rings in any orientation can be detected when contacting the single electrode. A double electrode design requires contact to both electrodes simultaneously.

FIG. 30 illustrates the cannulation task module 234. This task measures the ability to cannulate a small tube with both dominant and non-dominant hands. A flexible rod 420 is removed from a storage area 422 with the dominant hand and is inserted into a narrow, horizontally mounted tube 424 supported at its center. After pushing the rod 420 into the tube 424 from the side of the dominant hand, the rod 420 is grasped from the opposite side and extracted from the tube 424 in this direction. The task is then repeated in the reverse direction.

To monitor the passage of the flexible rod 420 through the tube 424, it is desirable to detect its direction of motion. To achieve this, the cannulation task sensor 234S, see FIG. 26, may comprise two separate sensors placed at different positions along the length of the tube 424. Two alternative sensing techniques may be employed to detect the rod at each position.

In an inductive sensing approach, a small inductive coil is mounted around the tube 424 at each of two positions. A flexible rod 420 containing a ferrous metal is used, for example a steel cable with a PVC jacket, and the tube 424 is formed of a non-conductive polymeric material. An electronic circuit measures the inductance of each coil. Such a circuit may be as depicted in FIG. 17. As the metallic rod 420 is introduced into the inductive coil, the metal displaces air in the coil, increasing its inductance. Likewise, the inductance returns to its former value when the metallic rod is removed. In an optical sensing approach, an infrared emitter and detector are mounted on opposite sides of the tube 424. The tube 424 is made from a transparent, flexible material such as PVC. The rod 420 interrupts the beam passing between emitter and detector, producing a measurable change in detector current. Such a circuit is conventional in nature and may be generally similar to that in FIG. 19, above. The circuitry for this approach is simpler to implement, and permits use of non-metallic materials for the rod 420.

FIG. 31 illustrates a task mechanism for a lasso loop knot preparation task. In this task, a small post 430 is extended on the top surface of the cover 208. A lasso loop knot is tied around this post using thread 432 and then presented for inspection. The post 430 may be stored in a storage area 434.

FIG. 32 illustrates the task mechanism for an intracoporeal knot cinching task using the knot tying task module 236. The previously prepared lasso loop knot 432, or alternatively a pre-formed suture loop, is brought into the enclosure through the front opening 206, see FIG. 22, or through one of the ports 212. The loop knot 432 is then looped around the free end of a vertical tube 436 and cinched with a knot pusher 438.

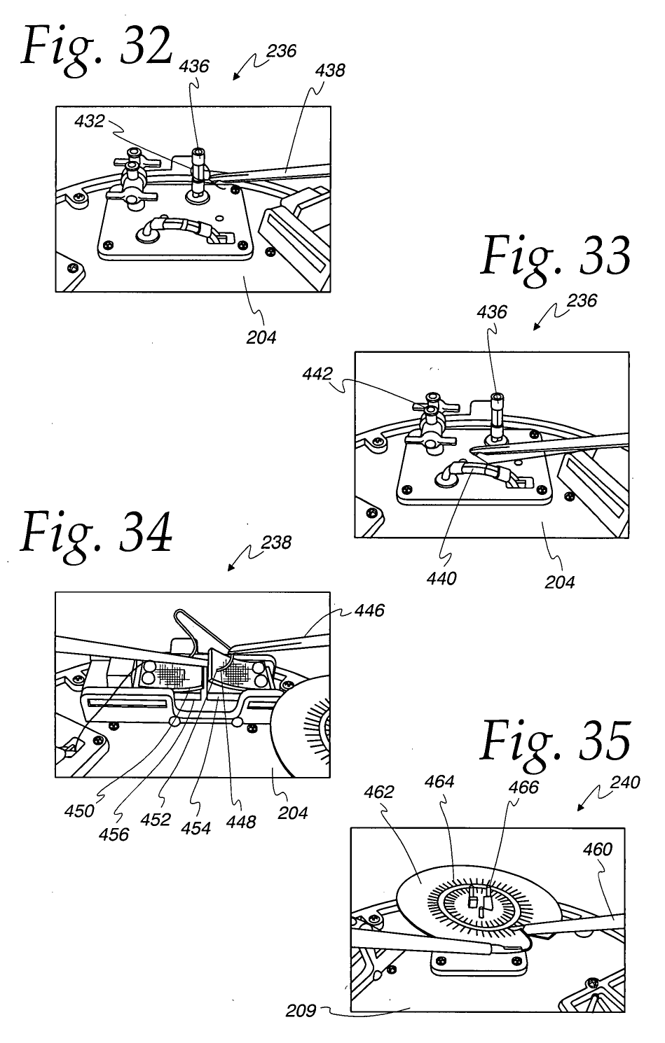

FIG. 33 illustrates use of the knot tying task module 236 for an extracorporeal knot tying and cinching task. A half-hitch knot is tied outside the enclosure 202, brought inside, and tied around the center of a horizontal tube 440 having fixed ends.

The vertical tube 436 and the horizontal tube 440 are intended to represent human tissue and are thus flexible. To detect the tying of the knot, the pressure in either tube 436 or 440 is measured by a knot tying task sensor 236S, see FIG. 26, such as a micromachined pressure sensor. The tubing, made from a highly elastic silicone rubber, contains a sealed volume of air exposure to a gauge-type pressure sensor. As the pressure changes resulting from simply cinching a knot is extremely small, the tube is folded over on itself to create a double tube. A double-tube cross section is more compliant than a single tube with respect to a circumferential cinching force exerted around its perimeter. As it collapses more readily, it produces a greater air pressure change.

The tubing material is subjected to mechanical stresses, oxidation, and unintended damage during removal of the completed knots using cutting devices. Thus, the tubing must be replaced occasionally. During tubing replacement, the air pressure within the sealed volume must be equalized with atmospheric pressure to maintain the sensing range of the pressure sensor. For this purpose, a pressure relief valve 442 is provided for each sensor. After replacement of the tube, the valve 442 is briefly opened and closed to equalize air pressure. Thus, the knot tying task sensor 236S comprises a gauge-type pressure sensor.

FIG. 34 illustrates the task mechanism for an intercorporeal suturing task and integrity test using the knot integrity task module 238. This task measures the ability to tie a well-formed and well-positioned intercorporeal knot between two flexible surfaces. A laparoscopic needle holder 446 and curved suturing needle 448 are used. Two suture ends are tied together with an intercorporial knot connecting fabric flaps 450 and 452. After the tying of the knot, the flaps 450 and 452 are drawn apart with a known force to test the knot's integrity. The knot integrity task sensor 238S senses whether the knot has held or has come loose.

The pair of fabric flaps 450 and 452 are supported by rigid mounting plates 454 and 456, respectively. The flaps 450 and 452 are made from a woven, durable fabric with high tensile strength, such as nylon webbing. The first mounting plate 454 is fixed. The second mounting plate 456 slides upon a linear track. The mobile plate 456 is connected to a servo motor (not shown). The mobile plate 456 also has a small magnet (not shown) attached to one end. The task sensor 238S comprises a magnetic sensor to detect the mobile plate 456 when it reaches a fully opened position. The magnetic sensor 238S can be conventional in nature, such as a magnetic reed switch, a hall effect sensor, or a linear potentiometer.

FIG. 35 illustrates the cutting task module 240 for a precision cutting task. This task measures the ability to cut material along a pre-defined path using laparoscopic scissors 460. A flexible, circular disk 462 is imprinted with a pattern of lines 464 that indicate the prescribed path. The disk is placed upon a mechanical support 466 in preparation for the task. During the task, the disk 462 is cut using the scissors 460 and then removed from the support 466 to indicate task completion. Penalties are applied for deviation from the prescribed path, as detected by observation of lines 464 imprinted on the disk 462.

The disk 462 is made from a printable, flexible, material such as Tyvek. Tyvek is a registered trademark of Dupont. A typical fabrication technique would include ink jet printing of the patterns onto a sheet and cutting the outer profile and mounting holes with a laser cutter to form the disk 462. The cutting task sensor 240S, see FIG. 26, may comprise an optical photo sensor 466 to detect the removal of the disk 462 from the support 466. When the disk is mounted on the support, the gap between an emitter and detector is blocked by the disk material 462, as generally discussed above. Removal of the disk 462 enables light to span this gap, thus signaling the completion of the task.

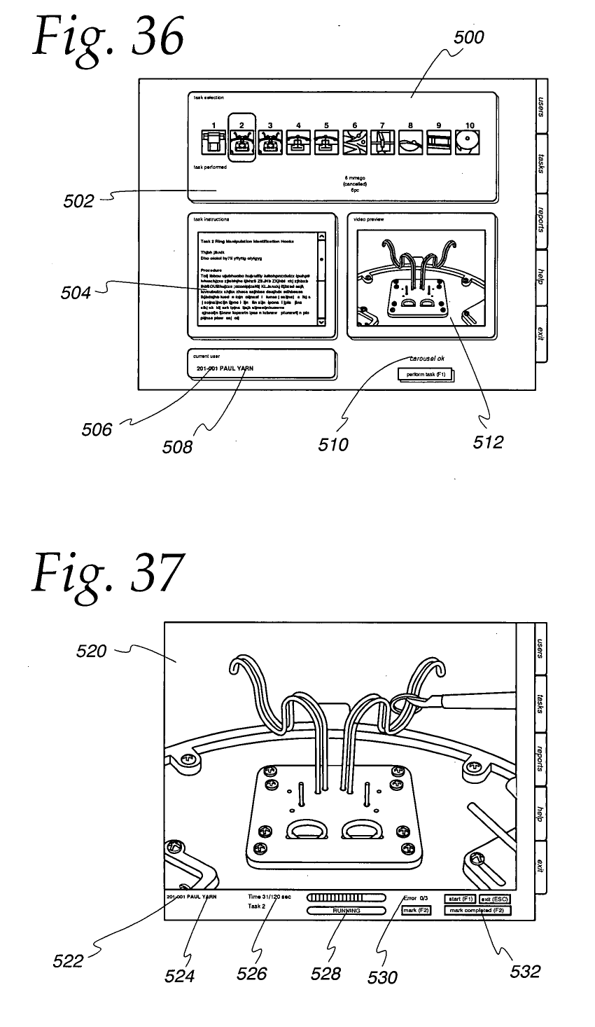

FIGS. 36, 37 and 38 illustrate screen displays shown on the display 220 during use under operation of the program of FIG. 27. FIG. 36 illustrates an interface for selecting from the available tasks at the block 308 of FIG. 27. The available tasks are illustrated in a top frame 500 in numbered sequence. For example, in the illustration, the user has selected the second task comprising the ring task sensor task. A task score for previously completed tasks can be displayed beneath the task selection in the area represented by 502. Instructions for the selected task are shown in a frame 504. A user ID is shown at 506 and user name at 508. The position of the carousel 204 is illustrated at 510, as well as instructions to rotate the carousel if necessary. Finally, a video preview of the task can be displayed at a frame 512.

FIG. 37 illustrates an interface for viewing live video and task information about the current task being formed. The main part of the display comprises a frame 520 in the form of a live video image. The user ID is shown at 522 and user name at 524. A time counter is shown at 526. The task status is shown at 528. An error counter is shown at 530. Finally, task controls are illustrated at 532.

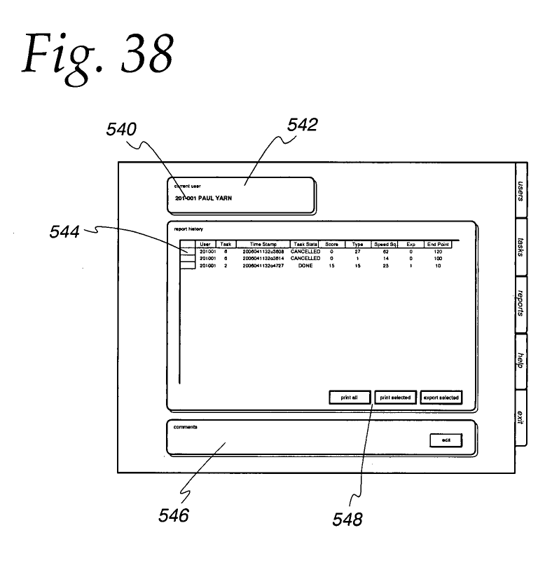

FIG. 38 illustrates a display for viewing live information about tasks performed by the current user of the system in the form of a report. A user ID is shown at 540, along with a user name at 542. Task records are illustrated in a frame 544 identifying the completed task and scoring information for the tasks. A comment field is provided in a frame 546. Finally, print and export controls are illustrated at 548.

Although not shown, the software may include help and demonstration software for viewing demonstration videos and help information for the available tasks.

Each of the medical training apparatus described above features concurrent display of video image and status information. This “dashboard-style” view enables convenient, real-time monitoring of performance on the task display. Also, task metrics are based on both time and accuracy. The task score is higher if performance is faster and if fewer errors are made.

With the embodiment 200 of FIG. 22, integration is also provided. Because the monitor, computer, carousel, and accessories are contained in a single enclosure, the final system is convenient to transport, set up, and operate. Such a design is more efficient to produce as it comprises simpler electronics, fewer power supplies, and less material overall. Most of the software has migrated from the microcontroller to the PC, where it is easier to develop, embellish, and upgrade.

Thus, in accordance with the invention, there is provided a medical training apparatus in the form of a laparoscopic training simulator that utilizes natural haptics, which provide realistic physical experience; electronic sensing, which enables objective real-time feedback and measurement; and digitization of the performance data, which allows for streamlined computer-based analysis. Particularly, the personal computer 49 provides a mechanism for logging test data. Software on the PC records task number and completion time to a spreadsheet or database file. The PC software can be configured to provide for operator enrollment, logging in and out, performance status feedback, rotating stage position, test control/controller status, device diagnostics, cumulative scores and user score logging and recall functions.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

We claim:

1. A self contained medical training apparatus comprising:
a portable enclosure defining a working space simulating a body cavity and having an access port to allow introduction of a medical instrument to the working space from externally of the working space;
a module in the working space upon which a medical procedure can be performed with a medical instrument;
a sensor operatively associated with the module for sensing progress of the medical procedure; and
a control unit in the enclosure and coupled to the sensor for monitoring progress of the medical procedure and providing an indication of status of the medical procedure.

2. The self contained medical training apparatus of claim 1 wherein the control unit comprises a programmed processing system.

3. The self contained medical training apparatus of claim 1 wherein the control unit comprises a video display integrally mounted to the enclosure.

4. The self contained medical training apparatus of claim 1 wherein the control unit comprises a video display hingedly mounted to the enclosure.

5. The self contained medical training apparatus of claim 4 wherein the enclosure includes a cover and the video display is moveable between a stowed position beneath the cover and an operating position extended above the cover.

6. The self contained medical training apparatus of claim 1 wherein the control unit comprises a video camera mounted within the enclosure.

7. The self contained medical training apparatus of claim 1 wherein the enclosure includes a cover and a video camera is mounted to an underside of the cover to retrieve images in the working space.

8. The self contained medical training apparatus of claim 7 wherein the control unit further comprises an illuminator to illuminate the working space.

9. The self contained medical training apparatus of claim 1 wherein the control unit comprises a camera and a video display operatively coupled to a processing system programmed to display images from the working space and information on status of the medical procedure.

10. The self contained medical training apparatus of claim 1 wherein the enclosure includes a carrying handle.

11. A medical training apparatus comprising:
a portable case defining a working space simulating a body cavity and having a port to allow introduction of a medical instrument to the working space from externally of the working space;
a carousel rotationally mounted in the working space for rotating the carousel to select angular positions for performing a series of simulated medical procedures;
a plurality of modules mounted around a perimeter of the carousel, each module comprising a different task upon which an associated medical procedure can be performed with a medical instrument;
a plurality of sensors each operatively associated with one of the modules for sensing progress of the associated medical procedure; and
a control unit coupled to the sensors for monitoring progress of the medical procedures and providing an indication of status of the medical procedures.

12. The medical training apparatus of claim 11 wherein the control unit comprises a programmed processing system housed in the portable case.

13. The medical training apparatus of claim 11 wherein the control unit comprises a video display integrally mounted to the case.

14. The medical training apparatus of claim 11 wherein the control unit comprises a video display hingedly mounted to the case.

15. The medical training apparatus of claim 14 wherein the portable case includes a cover and the video display is moveable between a stowed position beneath the cover and an operating position extended above the cover.

16. The medical training apparatus of claim 11 wherein the control unit comprises a video camera mounted within the case.

17. The medical training apparatus of claim 11 wherein the portable case includes a cover and a video camera is mounted to an underside of the cover to retrieve images in the working space.

18. The medical training apparatus of claim 17 wherein the control unit further comprises an illuminator to illuminate the working space.

19. The medical training apparatus of claim 11 wherein the control unit comprises a camera and a video display operatively coupled to a processing system programmed to display images from the working space and information on status of the medical procedure.

20. The medical training apparatus of claim 11 wherein the portable case includes a carrying handle.
